(19) United States
(12) Patent Application Publication
(10) Pub. No.: US 2021/0144739 A1
(43) Pub. Date: May 13, 2021

(54) SCHEDULING METHOD, LISTENING METHOD AND DEVICE FOR UNLICENSED BAND

(71) Applicant: VIVO MOBILE COMMUNICATION CO., LTD., Dongguan (CN)

(72) Inventors: Lei JIANG, Dongguan (CN); Zhi LU, Dongguan (CN); Xueming PAN, Dongguan (CN)

(73) Assignee: VIVO MOBILE COMMUNICATION CO., LTD., Dongguan (CN)

(21) Appl. No.: 17/151,095

(22) Filed: Jan. 15, 2021

Related U.S. Application Data
(63) Continuation of application No. PCT/CN2019/094523, filed on Jul. 3, 2019.

(30) Foreign Application Priority Data
Jul. 18, 2018 (CN) 201810791108.5

(51) Int. Cl. H04W 72/12; H04W 72/04; H04W 74/08; H04W 16/14; H04L 27/26

(52) U.S. Cl. CPC H04W 72/1278; H04W 72/0453; H04W 72/1215; H04W 16/14; H04L 27/2613; H04W 74/0808

(57) ABSTRACT

This disclosure provides a scheduling method, a listening method, and a device for an unlicensed band. The listening method includes: performing listening on one or more first subbands of an unlicensed band scheduled by a network device; or performing, based on bandwidth of the one or more first subbands, listening on one BWP or system bandwidth of the unlicensed band scheduled by the network device.

### CROSS-REFERENCE TO RELATED APPLICATIONS

This application is a bypass continuation of PCT Application No. PCT/CN2019/094523 filed Jul. 3, 2019, which claims priority to Chinese Patent Application No. 201810791108.5 filed in China on Jul. 18, 2018, both of which are incorporated herein by reference in their entireties.

### TECHNICAL FIELD

This disclosure relates to the technical field of communication, and specifically, to a scheduling method, a listening method and a device for an unlicensed band.

### BACKGROUND

In a future fifth generation (5^{th} Generation, 5G) communication system, or referred to as a new radio (NR) system, unlicensed bands can serve as a supplement to licensed bands to help an operator to expand services. In order to be consistent with NR deployment and maximize NR-based unlicensed access as far as possible, the unlicensed bands can work at the 5 GHz, 37 GHz and 60 GHz bands. Large bandwidth (80 MHz or 100 MHz) of an unlicensed band is able to reduce the complexity of implementing network and terminal devices. Since an unlicensed band is shared by a plurality of radio access technologies (RATs), such as wireless fidelity (WiFi), radar, and long term evolution license assisted access (LTE-LAA), in some countries or regions, the use of an unlicensed band is required to comply with some regulations, for example, rules such as listen before talk (LBT) and maximum channel occupancy time (MCOT), to ensure that all devices can use the resource fairly.

To transmit information, a transmission node needs to first implement LBT: performing energy detection (ED) on surrounding nodes, and when detected power is lower than a threshold, considering that the channel is idle, in which case the transmission node can perform transmission; otherwise, considering that the channel is busy, in which case the transmission node cannot perform transmission. The transmission node can be a base station, a terminal device, a WiFi access point (AP) or the like. After the transmission node starts transmission, the channel occupancy time cannot exceed MCOT.

In the NR system, the maximum channel bandwidth of each carrier can reach 400 MHz. However, considering capacity of the terminal device, the maximum bandwidth supported by the terminal device can be smaller than 400 MHz and the terminal device can work on a plurality of small bandwidth parts (BWPs). Each bandwidth part corresponds to one numerology, one bandwidth and one frequency location. The network device can configure a plurality of BWPs for the terminal device, in which case the network device needs to inform the terminal device which BWP to work on, meaning which BWP is to be activated. Activation or deactivation of the BWP can be indicated by downlink control information (DCI) signaling. After receiving an activation or deactivation instruction, the terminal device performs transmission on a corresponding active BWP. Likewise, on an unlicensed band, for a network device or terminal device to perform transmission on an active BWP, channel listening is also required and the transmission of information can start only when the channel is idle.

At present, on an unlicensed band, a scheduling mechanism in related technologies is prone to have information not transmitted due to the channel being busy, causing failed demodulation. This problem needs to be resolved urgently.

### SUMMARY

Some embodiments of this disclosure are intended to provide a scheduling method, a listening method and a device to solve issues related to resource allocation and scheduling for uplink transmission on an unlicensed band.

According to a first aspect, a method for scheduling on an unlicensed band, applied to a network device, is provided. The method includes: performing scheduling for a terminal device on one or more first subbands of the unlicensed band; or performing scheduling for the terminal device on one bandwidth part BWP or system bandwidth of the unlicensed band.

According to a second aspect, a method for listening on an unlicensed band, applied to a terminal device, is further provided. The method includes: performing listening on one or more first subbands of an unlicensed band scheduled by a network device; or performing, based on bandwidth of one or more first subbands, listening on one BWP or system bandwidth of the unlicensed band scheduled by the network device.

According to a third aspect, a network device is further provided, including: a first processing module, configured to perform scheduling for a terminal device on one or more first subbands of an unlicensed band; or perform scheduling for the terminal device on one BWP or system bandwidth of the unlicensed band.

According to a fourth aspect, a terminal device is further provided, including: a fourth processing module, configured to perform listening on one or more first subbands of an unlicensed band scheduled by a network device; or perform, based on bandwidth of one or more first subbands, listening on one BWP or system bandwidth of the unlicensed band scheduled by the network device.

According to a fifth aspect, a network device is further provided, including a processor, a memory, and a computer program stored in the memory and capable of running on the processor, where when the computer program is executed by the processor, the steps of the method for scheduling on an unlicensed band according to the first aspect are implemented.

According to a sixth aspect, a terminal device is further provided, including: a processor, a memory, and a computer program stored in the memory and capable of running on the processor, where when the computer program is executed by the processor, the steps of the method for scheduling on an unlicensed band according to the second aspect are implemented.

According to a seventh aspect, a computer-readable storage medium is further provided, where the computer-readable storage medium stores a computer program, and when the computer program is executed by a processor, the steps of the method for listening on an unlicensed band according to the first aspect or the second aspect are implemented.

In some embodiments of this disclosure, the terminal device can flexibly use resources of unlicensed bands, and the network device can correctly demodulate transmitted information, improving effectiveness and reliability of communication.

### BRIEF DESCRIPTION OF DRAWINGS

A person of ordinary skill in the art will be clear about other advantages and benefits by reading detailed description of the embodiments below. The accompanying drawings are merely intended to illustrate the objectives of the embodiments and are not intended to limit this disclosure. Throughout the accompanying drawings, the same reference signs represent the same components. In the drawings:

FIG. 1 is a schematic diagram representing an interlacing structure under an eLAA system;

FIG. 2 is a schematic architectural diagram of a wireless communications system according to some embodiments of this disclosure;

FIG. 3 is a flowchart of a method for scheduling on an unlicensed band according to some embodiments of this disclosure;

FIG. 4 is a flowchart of a method for listening on an unlicensed band according to some embodiments of this disclosure;

FIG. 5 is a first structural diagram of a network device according to some embodiments of this disclosure;

FIG. 6 is a first structural diagram of a terminal device according to some embodiments of this disclosure;

FIG. 7 is a second structural diagram of a network device according to some embodiments of this disclosure; and

FIG. 8 is a second structural diagram of a terminal device according to some embodiments of this disclosure.

### DESCRIPTION OF EMBODIMENTS

The following clearly and describes the technical solutions in some embodiments of this disclosure with reference to the accompanying drawings of the embodiments of this disclosure. Apparently, the described embodiments are some rather than all of the embodiments of this disclosure. All other embodiments that a person of ordinary skill in the art obtains without creative efforts based on the embodiments of this disclosure shall fall within the protection scope of this disclosure.

The terms “include”, “comprise”, or any of their variants in the specification and claims of this application are intended to cover a non-exclusive inclusion, such that a process, a method, a system, a product, or a device that includes a list of steps or units not only include those expressly listed steps or units but also include other steps or units that are not expressly listed, or inherent to such process, method, product, or device. Moreover, use of “and/or” in the specification and claims represent at least one of the connected objects. For example, A and/or B means three cases: A alone, B alone, or A and B together.

In some embodiments of this disclosure, the word such as “an example” or “for example” is used to represent giving an example, an instance, or an illustration. Any embodiment or design scheme described as “an example” or “for example” in some embodiments of this disclosure should not be construed as being more preferred or having more advantages than other embodiments or design schemes. Specifically, the terms such as “an example” or “for example” are intended to present related concepts in a specific manner.

The technologies described herein are not limited to a long term evolution (LTE)/LTE-Advanced (LTE-A) system, and are also applicable to various wireless communications systems, such as code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” are often used interchangeably. The CDMA system may implement radio technologies such as CDMA2000 and universal terrestrial radio access (UTRA). UTRA includes wideband CDMA (WCDMA) and other CDMA variants. The TDMA system may implement radio technologies such as global system for mobile communication (GSM). The OFDMA system may implement radio technologies such as ultra mobile broadband (UMB), evolved UTRA (E-UTRA), IEEE 802.11 (Wi-Fi), IEEE 802.16 (WiMAX), IEEE 802.20, and Flash-OFDM. UTRA and E-UTRA are part of the universal mobile telecommunications system (UMTS). LTE and more advanced LTE (such as LTE-A) are new UMTS versions using E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The technologies described in this specification may be used for the foregoing systems and radio technologies, and may also be used for other systems and radio technologies. However, in the following descriptions, an NR system is described for an illustration purpose, and NR terms are used in most of the following descriptions, although these technologies may also be applied to other applications than an NR system application.

The following describes the embodiments of this disclosure with reference to the accompanying drawings. The scheduling method, listening method and device provided in some embodiments of this disclosure may be applied to a wireless communications system. FIG. 2 is a schematic architectural diagram of a wireless communications system according to some embodiments of this disclosure. As shown in FIG. 2, the wireless communications system may include a network device 20 and a terminal device, for example, the terminal device is denoted as user equipment (UE) 21, and the UE 21 may communicate with the network device 20 (for transmitting signaling or data). In practical applications, the connection between the foregoing devices may be a wireless connection. For ease of visually representing the connection relationships between the devices, a solid line is used for illustration in FIG. 2. It should be noted that the above communications system may include a plurality of UEs 21, and that the network device 20 may communicate with the plurality of UEs 21.

The terminal device provided in some embodiments of this disclosure may be a mobile phone, a tablet computer, a notebook computer, an ultra-mobile personal computer (UMPC), a netbook, a personal digital assistant (PDA), a mobile Internet device (MID), a wearable device, an in-vehicle device, or the like.

The network device 20 provided in some embodiments of this disclosure may be a base station. The base station may be a commonly used base station or an evolved NodeB (eNB), or a network device in a 5G system (for example, a next generation NodeB (gNB), or a transmission and reception point (TRP)), or the like. It should be noted that, in some embodiments of this disclosure, the base station in the 5G system (gNB) is used as only an example, but the base station is not limited to any specific type.

The base station may communicate with the terminal device 21 under the control of a base station controller. In various examples, the base station controller may be a part of the core network or some base stations. Some base stations may exchange control information or user data with the core network by using backhaul. In some examples, some of these base stations may communicate with each other directly or indirectly by using backhaul links. The backhaul links may be wired or wireless communications links. The wireless communications system may support operations on multiple carriers (signals of the waveform in different frequencies). A multi-carrier transmitter can transmit modulated signals on the multiple carriers simultaneously. For example, multi-carrier signals modulated by using various radio technologies may be transmitted by each communication link. Each modulated signal may be sent on different carriers and may carry control information (for example, a reference signal or a control channel), overhead information, data, and the like.

The base station may communicate wirelessly with the terminal device 21 through one or more access point antennas. Each base station may provide communication coverage for a corresponding coverage area of the base station. A coverage area of an access point may be divided into sectors forming only a part of the coverage area. The wireless communications system may include different types of base stations (for example, a macro base station, a micro base station, or a picocell base station). The base station may also use different radio technologies, such as cellular and WLAN radio access technologies. The base station may be associated with a same or different access networks or operator deployments. Coverage areas of different base stations (including coverage areas of base stations of a same type or different types, coverage areas using a same radio technology or different radio technologies, or coverage areas of a same access network or different access networks) may overlap each other.

Communication links in the wireless communications system may include an uplink for carrying uplink (UL) transmission (for example, from the terminal device 21 to the network device 20), or a downlink for carrying downlink (DL) transmission (for example, from the network device 20 to the terminal device 21). The UL transmission may also be referred to as reverse link transmission, while the DL transmission may also be referred to as forward link transmission. A licensed band, an unlicensed band, or both may be used for downlink transmission. Similarly, a licensed band, an unlicensed band, or both may be used for uplink transmission.

Descriptions will be made as follows. According to regulations of an occupied channel bandwidth (OCB), on an unlicensed band, a transmission node is required to occupy at least 70% (60 GHz) or 80% (5 GHz) bandwidth of an entire band for each transmission. In order to solve this problem in uplink transmission, an enhanced licensed assisted access (eLAA) introduces interlaced resource block (RB) assignment. 100 RBs on 20 MHz bandwidth are evenly divided into 10 interlaces. Each interlace includes 10 equally spaced physical resource blocks (PRBs). As shown in FIG. 1, interlace 0 includes RBs 0, 10, 20, . . . , 90, interlace 1 includes RBs 1, 11, 21, . . . , 91, interlace 2 includes RBs 2, 12, 22, . . . , 92, interlace 3 includes RBs 3, 13, 23, . . . , 93, and by analog, interlace 9 includes RBs 9, 19, 29, . . . , 99. Upon scheduling, the terminal device can be allocated to one or more interlaces.

In NR, different subcarrier intervals are introduced. There are at most 275 RBs on each component carrier. Considering a guard interval at two ends, the number of RBs for maximum transmission bandwidth under different subcarrier intervals and different bandwidths is shown in Table 1 and Table 2.

TABLE 1

| | 5 | 10 | 15 | 20 | 25 | 30 | 40 | 50 | 60 | 70 | 80 | 90 | 100 |
|---|---|---|---|---|---|---|---|---|---|---|---|---|---|
| SCS | MHz | MHz | MHz | MHz | MHz | MHz | MHz | MHz | MHz | MHz | MHz | MHz | MHz |
| [kHz] | N_{RB} | N_{RB} | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | [160] | 216 | 270 | N.A | N.A | N.A | N.A | N.A |
| 30 | 11 | 24 | 38 | 51 | 65 | [78] | 106 | 133 | 162 | [189] | 217 | [245] | 273 |
| 60 | N.A | 11 | 18 | 24 | 31 | [38] | 51 | 65 | 79 | [93] | 107 | [121] | 135 |

TABLE 2

| SCS | 50 MHz | 100 MHz | 200 MHz | 400 MHz |
|---|---|---|---|---|
| [kHz] | N_{RB} | N_{RB} | N_{RB} | N_{RB} |
| 60 | 66 | 132 | 264 | N.A |
| 120 | 32 | 66 | 132 | 264 |

In related technologies, channel bandwidth of WiFi below 7 GHz is 20 MHz. Therefore, in order to avoid causing interference to existing WiFi, in NR, a base station (gNB) or a terminal device should also implement LBT based on 20 MHz. However, system bandwidth of NR or bandwidth of one BWP is far greater than 20 MHz. For simplicity, bandwidth of BWP can be defined according to an integral multiple of 20 MHz. For example, when bandwidth of BWP1 is 80 MHz, LBT needs to be performed on four 20 MHz channels on BWP1. Due to uncertainty of channel availability, the four 20 MHz channels are not necessarily idle or busy simultaneously. In this way, there may be only two 20 MHz channels being idle on 80 MHz bandwidth and the two channels may be continuous or discontinuous. In such a case, on an unlicensed band, a scheduling mechanism in related technologies is prone to have information not transmitted due to the channel being busy, causing failed demodulation.

Referring to FIG. 3, some embodiments of this disclosure provide a method for scheduling on an unlicensed band. The method may be performed by a network device, and the specific step of the method is as follows.

Step 301: Perform scheduling for a terminal device on one or more first subbands of the unlicensed band; or perform scheduling for the terminal device on one BWP or system bandwidth of the unlicensed band.

In some embodiments of this disclosure, the network device or the terminal device may perform listening based on bandwidth of the one or more first subbands. The first subband is also referred to as a subband of LBT, meaning that the network device or the terminal device performs listening in unit of the subband of LBT.

In some embodiments of this disclosure, optionally, the network device schedules interlacing of one BWP or system bandwidth of an unlicensed band to the terminal device, and the terminal device performs listening according to the scheduling on one BWP or system bandwidth in unit of a first subband (may be referred to as a subband of LBT or a subband for LBT) and performs transmission on a subband where a channel is detected to be idle.

In some embodiments of this disclosure, optionally, the first subband is at least a portion of one BWP or system bandwidth. For example, bandwidth of one BWP or system bandwidth can be an integral multiple of bandwidth of the first subband. For example, when bandwidth of one BWP is 80 MHz, bandwidth of the first subband can be 20 MHz, and one BWP includes four first subbands in total. It can be understood that bandwidth of the first subband and bandwidth of one BWP or system bandwidth are not specifically defined in some embodiments of this disclosure.

In some embodiments of this disclosure, optionally, the network device performs interlacing separately on resources of each of one or more first subbands of the unlicensed band. Further, the network device schedules interlace with the same index or different indices on different first subbands of the unlicensed band to the terminal device.

For example, the network device performs interlacing separately on resources of subband 1 and subband 2, to obtain interlace 0 and interlace 1 of the subband 1, and interlace 0 and interlace 1 of the subband 2. The network device schedules interlace 0 of the subband 1 and interlace 0 of the subband 2 to the terminal device, or the network device can schedule interlace 0 of the subband 1 and interlace 1 of the subband 2 to the terminal device. Optionally, frequency domain resource scheduling of the subband 1 and the subband 2 are indicated through a frequency domain resource assignment field. It can be understood that the foregoing subband 1 and subband 2 can also be known as subbands of LBT or subbands for LBT.

In some embodiments of this disclosure, optionally, the first subband corresponds to one or more code block groups (CBGs) according to a time-first mapping manner. For example, a transport block (TB) is mapped according to time-first mapping, so that each LBT subband corresponds to one or more CBGs.

In some embodiments of this disclosure, optionally, based on the method shown in FIG. 3, the method may further include: receiving first indication information, the first indication information indicating information related to one or more second subbands, where the terminal device is transmitting or not transmitting data on the one or more second subbands, and the information related to the second subbands can implicitly or explicitly indicate an actual transmission state of the second subbands. For example, the first indication information may include a plurality of bits, each of which corresponds to an actual transmission state of the second subbands. Optionally, “1” represents presence of data transmission and “0” represents absence of data transmission, or vice versa.

It can be understood that bandwidth of the second subbands may be the same as or different from bandwidth of the first subbands. The second subbands can also be known as subbands of LBT or subbands for LBT.

For example, the second subband can be one or more first subbands, that is, the first subbands when the channel is idle (or not idle). For example, for 80 MHz bandwidth, the network device schedules subband 1, subband 2 and subband 3, and the terminal device is transmitting data on the subband 1 and the subband 3 based on a listening result, in which case the first indication information can indicate “101”, where “1” represents a subband on which transmission is actually performed and “0” represents a subband on which no transmission is performed.

It can be understood that the first indication information can indicate a subband on which the terminal device is actually transmitting or not transmitting data. For example, the first indication information may be uplink control information (UCI), through which a subband on which the terminal device is actually transmitting or not transmitting data is indicated.

In some embodiments of this disclosure, optionally, the method shown in FIG. 3 may further include: based on a demodulation reference signal (DMRS) detection result, obtaining information related to one or more third subbands, where the terminal device is transmitting data on the one or more third subbands, and the information related to the third subbands can implicitly or explicitly indicate the third subbands.

It can be understood that bandwidth of the third subband can be the same as or different from bandwidth of the first subband, and the third subband can also be known as a subband of LBT or a subband for LBT.

For example, the third subband can be one or more first subbands. For example, 80 MHz bandwidth has four LBT subbands or first subbands in total. When the network device schedules subband 1, subband 2 and subband 4 and the terminal device is transmitting data on the subband 1 and the subband 4 based on a listening result, the first indication information may indicate “1001”, where “1” represents a subband on which data transmission is actually performed and “0” represents a subband on which no data transmission is performed. For the subband 3 that is not scheduled, “0” is also used to represent absence of data transmission. Further, the terminal device can indicate only information of the scheduled subband. For example, “101” is used to represent that among scheduled subbands, data transmission is performed on the first subband, namely the subband 1, and the third subband, namely the subband 4.

For example, the network device can perform DMRS detection on the subband of each LBT, and determine, based on a DMRS detection result, whether the terminal device is transmitting data on the subband of the LBT. DMRS can generate a corresponding sequence based on bandwidth of the subband of LBT.

In some embodiments of this disclosure, the terminal device can flexibly use resources of unlicensed bands, and the network device can correctly demodulate transmitted information, improving effectiveness and reliability of communication.

Referring to FIG. 4, some embodiments of this disclosure further provide a method for listening on an unlicensed band. The method may be performed by a terminal device, and the specific step of the method is as follows.

Step 401: Perform listening on one or more first subbands of an unlicensed band scheduled by a network device; or perform, based on bandwidth of one or more first subbands, listening on one BWP or system bandwidth of the unlicensed band scheduled by the network device.

In some embodiments of this disclosure, the first subband can also be known as a subband of LBT. The network device or terminal device performs listening based on bandwidth of one or more first subbands (in unit of the first subband).

For example, the network device schedules interlace 0 of subband 1 and interlace 0 of subband 2 to the terminal device, or the network device can schedule interlace 0 of the subband 1 and interlace 1 of the subband 2 to the terminal device. The terminal device performs listening on the scheduled subband 1 and subband 2. When the listened channel is idle, uplink transmission is performed according to scheduling. When the channel is not idle, transmission is skipped. It can be understood that the foregoing subband 1 and subband 2 can also be known as subbands of LBT or subbands for LBT.

In some embodiments of this disclosure, optionally, the first subband is at least a portion of one BWP or system bandwidth. For example, bandwidth of one BWP or system bandwidth can be an integral multiple of bandwidth of the first subband. For example, when bandwidth of one BWP is 80 MHz, bandwidth of the first subband can be 20 MHz, and one BWP includes four first subbands in total. It can be understood that bandwidth of the first subband and bandwidth of one BWP or system bandwidth are not specifically defined in some embodiments of this disclosure.

In some embodiments of this disclosure, optionally, the first subband corresponds to one or more CBGs according to a time-first mapping manner. For example, a transport block (TB) is mapped according to time-first mapping, so that each LBT subband corresponds to one or more CBGs.

In some embodiments of this disclosure, optionally, based on the method shown in FIG. 4, the method further includes: sending first indication information, the first indication information indicating information related to one or more second subbands, where the terminal device is transmitting or not transmitting data on the one or more second subbands, and the information related to the second subbands can implicitly or explicitly indicate an actual transmission state of the second subbands. For example, the first indication information may include a plurality of bits, each of which corresponds to an actual transmission state of the second subbands. Optionally, “1” represents presence of data transmission and “0” represents absence of data transmission, or vice versa.

Further, the terminal device sends the first indication information on one or more second subbands (or fixed resource elements (REs) of the second subband). The information related to the second subband can implicitly or explicitly indicate the second subband. It can be understood that bandwidth of the second subband is the same as bandwidth of the first subband, and the second subband can also be known as a subband of LBT or a subband for LBT.

For example, the second subband can be one or more first subbands, that is, the first subbands when the channel is idle (or not idle). For example, 80 MHz bandwidth has four LBT subbands or first subbands in total. When the network device schedules subband 1, subband 2 and subband 4 and the terminal device is transmitting data on the subband 1 and the subband 4 based on a listening result, the first indication information may indicate “1001”, where “1” represents a subband on which data transmission is actually performed and “0” represents a subband on which no data transmission is performed. For the subband 3 that is not scheduled, “0” is also used to represent absence of data transmission. Further, the terminal device can indicate only information of the scheduled subband. For example, “101” is used to represent that among scheduled subbands, data transmission is performed on the first subband, namely the subband 1, and the third subband, namely the subband 4.

For example, the first indication information may be UCI, through which a subband on which the terminal device is actually transmitting or not transmitting data is indicated.

In some embodiments of this disclosure, the terminal device can flexibly use resources of the unlicensed band and the network device can also correctly demodulate transmitted information.

### Example 1

In this example, interlace of resources is performed in unit of a subband of LBT. For example, interlace is performed in unit of 20 MHz. A gNB can add an indication field to DCI to indicate which LBT subbands are scheduled. For example, for one 80 MHz BWP, the indication field can be four bits, where “0” represents no scheduling and “1” represents scheduling, in which case “1100” represents that the first two 20 MHz LBT subbands in 80 MHz have been scheduled. For a subband of each LBT, scheduling information can be completely the same, or a different interlace can be scheduled on each subband. When a different interlace is scheduled on each subband, it is required to extend a frequency domain resource assignment field, so that this field can indicate frequency domain resource scheduling of a plurality of subbands.

The terminal device implements LBT separately on scheduled LBT subbands, and when the channel is detected to be idle, performs uplink transmission according to scheduling. When the channel is not idle, transmission is skipped, meaning no transmission is performed.

### Example 2

In this example, resources can be interlaced and scheduled based on one BWP or system bandwidth. The terminal device can implement LBT based on subbands of LBT on resources corresponding to the BWP or system bandwidth, and determine, based on an LBT result, whether to perform uplink transmission on the corresponding resources. Transmissions on subbands of each LBT may be fully duplicate based on subbands, or different redundancy versions (RVs) may be sent on subbands of each LBT.

### Example 3

Since a gNB does not know channel access state of the terminal device, the gNB does not know on which LBT subbands the terminal device performs uplink transmission. The terminal device can transmit UCI on a fixed resource element (RE) of a subband of each LBT, indicating an LBT subband on which actual transmission is or is not performed. For example, the UCI has x bits in total and each bit corresponds to an actual transmission state of one subband, with “1” representing presence of data transmission and “0” representing absence of data transmission, or vice versa. Assuming x=4, “1001” represents that data transmission is performed on the first and fourth LBT subbands, and no data transmission is performed on the other two LBT subbands.

Alternatively, the gNB can perform DMRS detection on each LBT subband, and determine, based on a DMRS detection result, whether the terminal device is transmitting data on the LBT subband. The DMRS generates a corresponding sequence based on bandwidth of the LBT subband.

For an LBT subband on which the channel is busy, the terminal device can perform rate matching or puncture. The gNB demodulates received data based on the rate matching or puncture. The terminal device preferentially adopts the rate matching. If the rate matching exceeds a maximum code rate, the remaining bits are punctured.

### Example 4

On an entire BWP or system bandwidth, a transport block (TB) is mapped according to time-first mapping, so that each LBT subband corresponds to one or more full CBGs. The gNB performs scheduling for the terminal device based on the CBGs. The terminal device implements LBT on a subband of LBT corresponding to the scheduled CBG, and transmits the corresponding CBG on the subband of the LBT when the channel is detected to be idle, or skips transmission when the channel is detected to be busy. The gNB determines, based on the received information, which CBGs are not transmitted or incorrectly transmitted, and performs re-scheduling for these CBGs.

In some embodiments of this disclosure, a network device is further provided. Since the problem solving principles of the network device are similar to those in the method for scheduling on an unlicensed band in some embodiments of this disclosure, for the implementation of the network device, reference may be made to the implementation of the method, and details are not repeated.

Referring to FIG. 5, some embodiments of this disclosure provide a network device. The network device 500 includes:

a first processing module 501, configured to perform scheduling for a terminal device on one or more first subbands of an unlicensed band; or perform scheduling for the terminal device on one BWP or system bandwidth of the unlicensed band.

In some embodiments of this disclosure, optionally, the network device or the terminal device performs listening based on bandwidth of the one or more first subbands.

In some embodiments of this disclosure, optionally, based on FIG. 5, the network device further includes: a second processing module, configured to perform interlacing separately on resources of each of the one or more first subbands of the unlicensed band.

In some embodiments of this disclosure, optionally, the first processing module 501 is further configured to schedule interlace with the same index or different indices on different first subbands of the unlicensed band to the terminal device.

In some embodiments of this disclosure, optionally, the first subband is at least a portion of one BWP or system bandwidth.

In some embodiments of this disclosure, optionally, the first processing module 501 is further configured to schedule interlacing in one BWP or system bandwidth of the unlicensed band to the terminal device.

In some embodiments of this disclosure, optionally, the first subband corresponds to one or more CBGs according to a time-first mapping manner.

In some embodiments of this disclosure, optionally, based on FIG. 5, the network device further includes:

a receiving module, configured to receive first indication information, the first indication information indicating information related to one or more second subbands, where the terminal device is transmitting or not transmitting data on the one or more second subbands.

In some embodiments of this disclosure, optionally, based on FIG. 5, the network device further includes:

a third processing module, configured to, based on a DMRS detection result, obtain information related to one or more third subbands, where the terminal device is transmitting data on the one or more third subbands.

The network device provided according to some embodiments of this disclosure can execute the foregoing method embodiment, with a similar implementation principle and similar technical effects. Details are not repeated herein in this embodiment.

Some embodiments of this disclosure further provide a terminal device. Since the problem solving principles of the terminal device are similar to those in the method for listening on the unlicensed band in some embodiments of this disclosure, for the implementation of the terminal device, reference may be made to the implementation of the method, and details are not repeated.

Referring to FIG. 6, some embodiments of this disclosure further provide a terminal device. The terminal device 600 includes:

a fourth processing module 601, configured to perform listening on one or more first subbands of an unlicensed band scheduled by a network device; or perform, based on bandwidth of one or more first subbands, listening on one BWP or system bandwidth of the unlicensed band scheduled by the network device.

In some embodiments of this disclosure, optionally, the first subband is at least a portion of one BWP or system bandwidth.

In some embodiments of this disclosure, optionally, the first subband corresponds to one or more CBGs according to a time-first mapping manner.

In some embodiments of this disclosure, optionally, based on FIG. 6, the terminal device further includes:

a sending module, configured to send first indication information, the first indication information indicating information related to one or more second subbands, where the terminal device is transmitting or not transmitting data on the one or more second subbands.

The terminal device provided according to some embodiments of this disclosure can execute the foregoing method embodiment, with a similar implementation principle and similar technical effects. Details are not repeated herein in this embodiment.

Referring to FIG. 7, FIG. 7 is a structural diagram of a network device applied according to some embodiments of this disclosure. As shown in FIG. 7, the network device 700 includes a processor 701, a transceiver 702, a memory 703, and a bus interface.

In one embodiment of this disclosure, the network device 700 further includes a computer program stored in the memory 703 and capable of running on the processor 701, where when the computer program is executed by the processor 701, the following step is implemented: performing scheduling for a terminal device on one or more first subbands of an unlicensed band; or performing scheduling for the terminal device on one BWP or system bandwidth of the unlicensed band.

In FIG. 7, the bus architecture may include any quantity of interconnected buses and bridges, and specifically connects together various circuits of one or more processors represented by the processor 701 and a memory represented by the memory 703. The bus architecture may further interconnect various other circuits such as a peripheral device, a voltage regulator, and a power management circuit. These are all well known in the art, and therefore are not further described in this specification. The bus interface provides an interface. The transceiver 702 may be a plurality of elements, including a transmitter and a receiver, and provides units configured to perform communication with various other apparatuses over a transmission medium.

The processor 701 is responsible for management of the bus architecture and general processing, and the memory 703 may store data used by the processor 701 when an operation is performed.

The network device provided according to some embodiments of this disclosure can execute the foregoing method embodiment, with a similar implementation principle and similar technical effects. Details are not repeated herein in this embodiment.

As shown in FIG. 8, a terminal device 800 shown in FIG. 8 includes at least one processor 801, a memory 802, at least one network interface 804, and a user interface 803. The components in the terminal device 800 are coupled together through a bus system 805. It may be understood that the bus system 805 is configured to implement connection and communication between these components. In addition to a data bus, the bus system 805 further includes a power bus, a control bus, and a status signal bus. However, for clarity of description, various buses are marked as the bus system 805 in FIG. 8.

The user interface 803 may include a display, a keyboard, or a pointing device (for example, a mouse, a trackball (trackball), a touch panel, or a touchscreen).

It may be understood that the memory 802 in some embodiments of this disclosure may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of example but not restrictive description, many forms of RAM may be used, for example, a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct rambus random access memory (DRRAM). The memory 802 of the system and the method described in some embodiments of this disclosure is intended to include but not be limited to these and any other applicable types of memories.

In some embodiments, the memory 802 stores the following elements: executable modules or data structures, or a subset thereof, or an extended set thereof: an operating system 8021 and an application program 8022.

The operating system 8021 includes various system programs, such as a framework layer, a core library layer, and a driver layer, for implementing various basic services and processing hardware-based tasks. The application program 8022 includes various application programs, such as a media player and a browser, which are used to implement various application services. A program for implementing the method in some embodiments of this disclosure may be included in the application program 8022.

In one embodiment of this disclosure, by calling a program or instruction stored in the memory 802, which may specifically be a program or instruction stored in the application program 8022, the following step is implemented: performing listening on one or more first subbands of an unlicensed band scheduled by a network device; or performing, based on bandwidth of one or more first subbands, listening on one BWP or system bandwidth of the unlicensed band scheduled by the network device.

The terminal device provided according to some embodiments of this disclosure can execute the foregoing method embodiment, with a similar implementation principle and similar technical effects. Details are not repeated herein in this embodiment.

The method or algorithmic steps described in combination with the content disclosed in this disclosure may be implemented by hardware, or may be implemented by a processor executing software instructions. The software instruction may consist of a corresponding software module. The software module may be stored in a RAM, a flash memory, a ROM, an EPROM, an EEPROM, a register, a hard disk, a removable hard disk, a CD-ROM, or a storage medium of any other form known in the art. An example storage medium is coupled to the processor, so that the processor can read information from the storage medium or write information into the storage medium. Certainly, the storage medium may also be a component of the processor. The processor and the storage medium may be located in an ASIC. In addition, the ASIC may be located in a core network interface device. Certainly, the processor and the storage medium may exist in the core network interface device as discrete components.

A person skilled in the art should be aware that in the foregoing one or more examples, functions described in this disclosure may be implemented by hardware, software, firmware, or any combination thereof. When software is used for implementation, the foregoing functions may be stored in a computer-readable medium or transmitted as one or more instructions or codes in the computer-readable medium. The computer-readable medium includes a computer storage medium and a communications medium, where the communications medium includes any medium that enables a computer program to be transmitted from one place to another place. The storage medium may be any available medium accessible by a general-purpose or dedicated computer.

The objectives, technical solutions, and benefits of this disclosure are further described in detail in the foregoing specific implementations. It should be understood that the foregoing descriptions are merely specific implementations of this disclosure, but are not intended to limit the protection scope of this disclosure. Any modification, equivalent replacement, or improvement made based on the technical solutions in this disclosure shall fall within the protection scope of this disclosure.

A person skilled in the art should understand that some embodiments of this disclosure may be provided as a method, a system, or a computer program product. Therefore, some embodiments of this disclosure may be hardware-only embodiments, software-only embodiments, or embodiments with a combination of software and hardware. Moreover, some embodiments of this disclosure may be implemented in the form of one or more computer program products implemented on a computer-usable storage medium (including but not limited to a disk memory, a CD-ROM, an optical memory, and the like) that includes computer-usable program code.

Some embodiments of this disclosure are described with reference to the flowcharts and/or block diagrams of the method, the device (system), and the computer program product according to some embodiments of this disclosure. It should be understood that computer program instructions may be used to implement each process and/or each block in the flowcharts and/or the block diagrams, or a combination of a process and/or a block in the flowcharts and/or the block diagrams. These computer program instructions may be provided to a general-purpose computer, a special-purpose computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Obviously, a person skilled in the art can make various modifications and variations to some embodiments of this disclosure without departing from the spirit and scope of this disclosure. In this way, this disclosure is also intended to cover these modifications and variations to some embodiments of this disclosure provided that they fall within the protection scope defined by the claims of this disclosure and their equivalent technologies.

What is claimed is:

1. A method for listening on an unlicensed band, applied to a terminal device, the method comprising:
performing listening on one or more first subbands of an unlicensed band scheduled by a network device; or
performing, based on bandwidth of the one or more first subbands, listening on one BWP or system bandwidth of the unlicensed band scheduled by the network device.

2. The method according to claim 1, wherein
a first subband is at least a portion of the one BWP or system bandwidth.

3. The method according to claim 1, wherein
a first subband corresponds to one or more CBGs according to a time-first mapping manner.

4. The method according to claim 1, further comprising:
sending first indication information, the first indication information indicating information related to one or more second subbands, wherein the terminal device is transmitting or not transmitting data on the one or more second subbands.

5. A network device, comprising a processor, a memory, and a computer program stored in the memory and capable of running on the processor, wherein the computer program, when executed by the processor, causes the network device to implement a method for scheduling on an unlicensed band, the method comprising:
performing scheduling for a terminal device on one or more first subbands of the unlicensed band; or
performing scheduling for the terminal device on one bandwidth part (BWP) or system bandwidth of the unlicensed band.

6. The network device according to claim 5, wherein the network device or the terminal device performs listening based on bandwidth of the one or more first subbands.

7. The network device according to claim 5, wherein the method further comprises:
performing interlacing separately on resources of each of the one or more first subbands of the unlicensed band.

8. The network device according to claim 7, wherein performing scheduling for a terminal device on one or more first subbands of the unlicensed band comprises:
scheduling interlace with a same index or interlace with different indices on different first subbands of the unlicensed band to the terminal device.

9. The network device according to claim 5, wherein
a first subband is at least a portion of the one BWP or system bandwidth.

10. The network device according to claim 5, wherein
a first subband corresponds to one or more code block groups (CBGs) according to a time-first mapping manner.

11. The network device according to claim 5, wherein performing scheduling for the terminal device on one BWP or system bandwidth of the unlicensed band comprises:
scheduling interlacing in the one BWP or system bandwidth of the unlicensed band to the terminal device.

12. The network device according to claim 5, wherein the method further comprises:
receiving first indication information, the first indication information indicating information related to one or more second subbands, wherein the terminal device is transmitting or not transmitting data on the one or more second subbands.

13. The network device according to claim 5, wherein the method further comprises:
based on a demodulation reference signal (DMRS) detection result, obtaining information related to one or more third subbands, wherein the terminal device is transmitting data on the one or more third subbands.

14. A terminal device, comprising a processor, a memory, and a computer program stored in the memory and capable of running on the processor, wherein the computer program, when executed by the processor, causes the terminal device to implement a method for listening on an unlicensed band, the method comprising:
performing listening on one or more first subbands of an unlicensed band scheduled by a network device; or
performing, based on bandwidth of the one or more first subbands, listening on one BWP or system bandwidth of the unlicensed band scheduled by the network device.

15. The terminal device according to claim 14, wherein
a first subband is at least a portion of the one BWP or system bandwidth.

16. The terminal device according to claim 14, wherein
a first subband corresponds to one or more CBGs according to a time-first mapping manner.

17. The terminal device according to claim 14, wherein the method further comprises:
sending first indication information, the first indication information indicating information related to one or more second subbands, wherein the terminal device is transmitting or not transmitting data on the one or more second subbands.
